(19) United States
(12) Patent Application Publication
(10) Pub. No.: US 2020/0042687 A1
(43) Pub. Date: Feb. 6, 2020

(54) METHOD AND DEVICE FOR AUTHENTICATING USER USING USER'S BEHAVIOR PATTERN

(71) Applicant: LG ELECTRONICS INC., Seoul (KR)

(72) Inventors: Won Kwang CHOI, Incheon (KR); Jin Seok YANG, Seoul (KR)

(21) Appl. No.: 16/599,894

(22) Filed: Oct. 11, 2019

(30) Foreign Application Priority Data
Aug. 6, 2019 (KR) 10-2019-0095521

(51) Int. Cl. G06F 21/32; G06N 3/08; G06F 3/0346; G06F 3/0488

(52) U.S. Cl. CPC G06F 21/32; G06F 3/0488; G06F 3/0346; G06N 3/08

(57) ABSTRACT

A method for authenticating a user of a portable computing device according to an embodiment of the present disclosure includes identifying an application executed on the portable computing device, collecting touch data on the portable computing device and/or motion data of the portable computing device during execution of the application, and determining whether the pattern of the collected touch data and/or motion data corresponds to a usage pattern profile associated with the identified application. Whether the pattern of the touch data and/or the motion data corresponds to the usage pattern profile is determined in a Machine Learning or Deep Learning manner using an artificial neural network trained to output the corresponding degree between the usage pattern profile and the input data. According to the present disclosure, it is possible to authenticate the user in real time without disturbing the user during the use of the portable computing device.

### CROSS-REFERENCE TO RELATED APPLICATION

This application claims benefit of priority to Korean Patent Application No. 10-2019-0095521, entitled “METHOD AND DEVICE FOR AUTHENTICATING USER USING USER'S BEHAVIOR PATTERN,” filed on Aug. 6, 2019, in the Korean Intellectual Property Office, the entire disclosure of which is incorporated herein by reference.

### BACKGROUND

### 1. Technical Field

The present disclosure relates to a method for authenticating a user, and more particularly, to a method and a device for authenticating a user by means of a behavior pattern of a user using a device.

### 2. Description of Related Art

A portable computing device such as a smartphone is evolving to become smarter and to collect and use more vast amounts of data. For convenience, many portable computing devices store and use sensitive information such as Personal Identifying Information (PII) or Sensitive Personal Information (SPI) of the user. There is a concern that the sensitive information of the user may be leaked when someone else acquires such a portable computing device. Accordingly, many portable computing devices are often locked such that information inside the device can be accessed only after the user authentication.

For user's access, the user authentication by means of a Personal Identification Number (PIN) or a predetermined pattern has conventionally been used. Recently, the user authentication by means of biometric identification such as fingerprint, face, or iris recognition has been widely used. The user authentication by means of biometric identification provides convenience to the user in that the user does not have to remember a PIN or a predetermined pattern, and the user authentication can be done without cumbersome input.

The user authentication by means of the PIN or the predetermined pattern, or the biometric identification described above authenticates the user one-time. Once the user is authenticated, the device may be freely exposed to the user's access until the device is locked again. Generally, a device is changed to a locked state when it is not accessed by the user for more than a predetermined time. At this time, if the predetermined time is too short, user convenience may deteriorate, and if the predetermined time is too long, security may deteriorate. For example, if the predetermined time is long, there is a possibility that the device leaving the user's hand is kept in an unlocked state and someone else may acquire the unlocked device.

### SUMMARY OF THE DISCLOSURE

An object of the present disclosure is to authenticate in real time during the use a portable computing device whether it is used by a legitimate user.

Another object of the present disclosure is to block access of the portable computing device when someone else uses the portable computing device.

Still another object of the present disclosure is to keep the portable computing device in an unlocked state while the legitimate user is using the portable computing device.

Yet another object of the present disclosure is to determine whether a user is a legitimate user in a manner that does not disturb the user and is not recognized by the user.

The present disclosure is not limited to solving the above-described problems, and other aspects and advantages of the present disclosure may be appreciated by those skilled in the art based on the following description and will be understood more clearly from embodiments of the present disclosure. Further, it will be appreciated that the aspects and advantages of the present disclosure will be easily realized by those skilled in the art based on the appended claims and a combination thereof.

According to embodiments of the present disclosure, whether a user is legitimate user or not is determined based on the pattern of touch on a portable computing device and/or a motion of the portable computing device.

A method for authenticating a user of a portable computing device according to one aspect of the present disclosure includes identifying an application executed on the portable computing device, collecting touch data on the portable computing device and/or motion data of the portable computing device during execution of the application, and determining whether a pattern of the collected touch data and/or motion data corresponds to a usage pattern profile associated with the identified application.

A portable computing device according to another aspect of the present disclosure includes a touch screen configured to sense touch on a touch screen to generate touch data, a three-dimensional motion sensor configured to sense a motion in three-dimensional space of the portable computing device to generate motion data, one or more processors configured to execute one or more applications, and a memory configured to store one or more usage pattern profiles, wherein the one or more usage pattern profiles are associated with the one or more applications, respectively, and the one or more processors are operable to identify an application being executed, collect the touch data and/or the motion data from the touch screen and/or the three-dimensional motion sensor during execution of the application, and determine whether a pattern of the collected touch data and/or motion data corresponds to the usage pattern profile associated with the identified application.

In an embodiment, the touch data and/or the motion data may be collected for a predetermined time depending on the executed application.

In another embodiment, the touch data may include at least one of a touch coordinate, a number of multi-touches, a number of touch times, or a touch duration on a touch screen.

In still another embodiment, the motion data may include at least one of acceleration data or rotation data of the portable computing device in three-dimensional space.

In yet another embodiment, an artificial neural network is used to determine whether the pattern of the collected touch data and/or motion data corresponds to the usage pattern profile associated with the identified application.

In still yet another embodiment, the collected touch data and/or motion data are converted into image data to be input to the artificial neural network.

In further embodiment, additional measures for authenticating the user are performed, when the pattern of the collected touch data and/or motion data does not correspond to the usage pattern profile.

In further another embodiment, the usage pattern profile is generated upon installation of a new application or upon first execution of the new application, and the usage pattern profile is updated using the collected touch data and/or motion data during the execution of the new application.

According to the present disclosure, it is possible to use the data generated in real time while using the portable computing device for authenticating the user, thereby authenticating the user in real time during the use of the portable computing device.

Further, according to the present disclosure, it is possible to use the data generated in use for authenticating the user without requiring the separate input from the user, thereby authenticating the user without disturbing the user.

Further, according to the present disclosure, it is possible to block the access of the portable computing device when the pattern of the touch data and/or the motion data does not correspond to the usage pattern profile, thereby effectively blocking the use of the portable computing device by someone else.

Further, according to the present disclosure, it is possible to keep the portable computing device in the unlocked state while the legitimate user is using the portable computing device, thereby enhancing user convenience.

The effects of the present disclosure are not limited to the above-described effects, and other effects not described will be clearly understood by those skilled in the art from the description of the claims.

### BRIEF DESCRIPTION OF THE DRAWINGS

FIG. 1 is a block diagram showing a portable computing device according to an embodiment of the present disclosure.

FIG. 2 is a diagram showing the motions in the three dimensional space of the portable computing device.

FIGS. 3A to 3D are diagrams showing various examples of a method for gripping the portable computing device by a user.

FIGS. 4A to 4D are diagrams showing the examples in which various gripping methods of the portable computing device cause various touch data depending on the executed application.

FIGS. 5A and 5B are diagrams showing the examples in which various gripping methods of the portable computing device cause various motions data.

FIG. 6 is a flowchart showing a method for generating and learning a usage pattern profile in the portable computing device according to an embodiment of the present disclosure.

FIGS. 7A to 7D are diagrams showing a method for converting touch data into image data according to an embodiment of the present disclosure.

FIGS. 8A to 8D are diagrams showing a method for converting motion data into image data according to an embodiment of the present disclosure.

FIG. 9 is a flowchart showing a method for authenticating a user according to a usage pattern in the portable computing device according to an embodiment of the present disclosure.

FIG. 10 is a graph showing the time points when data training and usage pattern authentication are performed according to an embodiment of the present disclosure.

### DETAILED DESCRIPTION

Advantages and features of the present disclosure and methods for achieving them will become apparent from the descriptions of aspects herein below with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and accordingly specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms may be used herein only to describe various elements, but these elements should not be limited by these terms. These terms may be only used to distinguish one element, component, region, layer or section from another region, layer or section.

Hereinbelow, the embodiments of the present disclosure will be described in greater detail with reference to the accompanying drawings, and on all these accompanying drawings, the identical or analogous elements are designated by the same reference numeral, and repeated description of the common elements will be omitted.

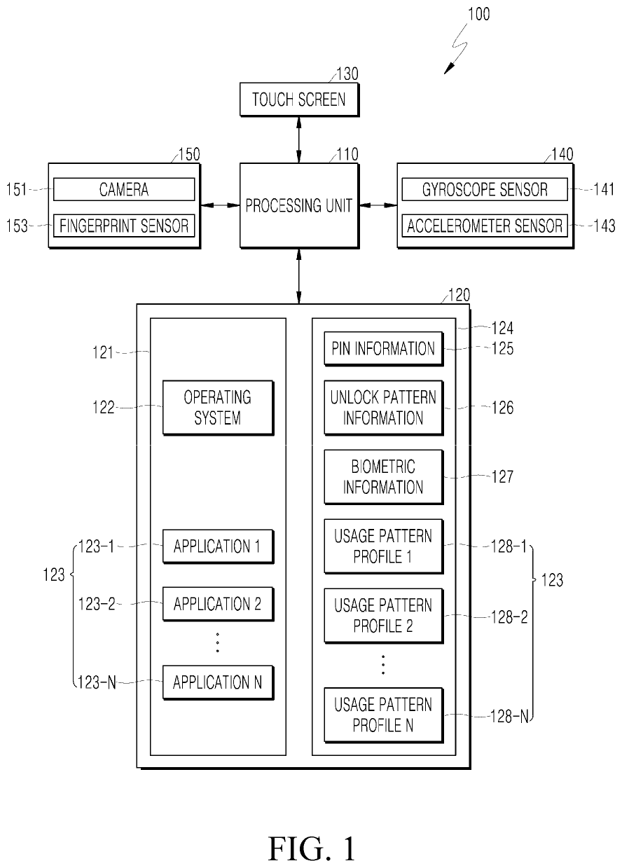

FIG. 1 is a block diagram showing a portable computing device according to an embodiment of the present disclosure.

Referring to FIG. 1, a portable computing device 100 may include a memory 120, a touch screen 130, a three-dimensional motion sensor 140, and a biometric sensor 150, and a processing unit 110 electrically, commutatively connected thereto. The portable computing device 100 may be, for example, a mobile phone, a smartphone, a tablet computer, a laptop computer, a palmtop computer, a personal digital assistant (PDA), a music player, or a portable game console, etc., but is not limited thereto.

The processing unit 110 may be, for example, any form of data processing device implemented in hardware having a structured circuitry in order to perform functions represented by codes or instructions included in a computer program. The processing unit 110 may include, for example, one or more processors including a mobile processor, an application processor (AP), a microprocessor, a central processing unit (CPU), a graphic processing unit (GPU), a neural processing unit (NPU), a processor core, a multiprocessor, an application-specific integrated circuit (ASIC), or a field programmable gate array (FPGA), but is not limited thereto.

The processing unit 110 controls operations of the portable computing device 100 in accordance with a computer program 121 stored in the memory 120. For example, the processing unit 110 may control operations of the portable computing device 100 in accordance with instructions of an operating system 122 stored in the memory 120. The processing unit 110 may also perform functions in accordance with instructions of one or more applications 123 stored in the memory 120.

The memory 120 may be a tangible computer readable medium for storing computer programs 121 executed by the processing unit 110 and/or data associated with the computer programs. The computer program 121 includes the operating system 122 for managing hardware of the portable computing device and providing a platform for executing the applications 123. The computer program 121 may also include one or more applications 123-1, 123-2, 123-N executed on the operating system 122. The application 123 may include, for example, one or more of a web browser, a virtual keyboard, an instant messenger, a multimedia player, a social media service, or a game, but is not limited thereto.

The memory 120 may also include authentication data 124 for authenticating the user. The authentication data 124 may include PIN information 125 of the user, unlock pattern information 126, biometric information 127, and one or more usage pattern profiles 128. The PIN information 125, the unlock pattern information 126, and/or the biometric information 127 may be encrypted in a manner in which the original data is not recognizable and stored in the memory 120.

The usage pattern profiles 128-1, 128-2, 128-N are associated with applications 123-1, 123-2, 123-N, respectively. For example, the first usage pattern profile 128-1 is associated with the first application 123-1, the second usage pattern profile 128-2 is associated with the second application 123-2, and the N^{th} usage pattern profile 128-N is associated with the third application 123-N.

The touch screen 130 is an input/output device for displaying texts, graphics, images, or videos in accordance with the execution of the operating system or the application, and at the same time, sensing the user touching the screen with a finger or a stylus on the screen to generate touch data.

The three-dimensional motion sensor 140 is a sensor for detecting a motion of the portable computing device in three-dimensional space, and generating motion data representing the motion. The three-dimensional motion sensor 140 may include a gyroscope sensor 141 for detecting rotation of the portable computing device in three-dimensional space and an accelerometer sensor 143 for detecting translational acceleration motion of the portable computing device in three-dimensional space.

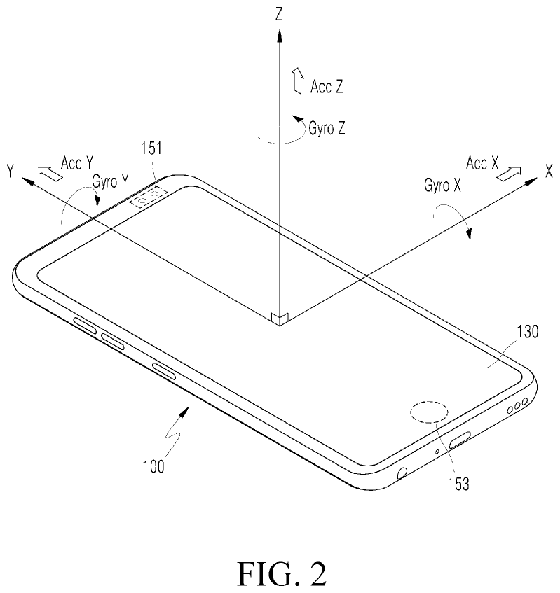

FIG. 2 is a diagram showing motions in three-dimensional space of the portable computing device. Referring to FIG. 2, the gyroscope sensor 141 may generate signals (GyroX, GyroY, GyroZ) representing rotations (pitch, roll, yaw) of the portable computing device around three axes (x-axis, y-axis, z-axis) of the portable computing device. The accelerometer sensor 143 may generate signals (AccX, AccY, AccZ) representing acceleration along three directions (x-direction, y-direction, z-direction) in three-dimensional space. In the present specification, the direction parallel to the shorter side of the touch screen 130 of the portable computing device 100 is defined as the x-direction, the direction parallel to the longer side of the touch screen 130 is defined as the y-direction, and the direction perpendicular to the touch screen 130 is defined as the z-direction. However, the x, y, z directions in the present specification are merely illustrative and may be defined in various directions according to different references.

Referring back to FIG. 1, the biometric sensor 150 includes one or more sensors for collecting biometric information for authenticating a user. The biometric sensor 150 may include, for example, a camera 151 for recognizing face or iris of the user and a fingerprint sensor 153 for recognizing a user's fingerprint. In an embodiment, the fingerprint sensor 153 may also be integrated as part of the touch screen 130.

Although not shown in FIG. 1 for the sake of simplicity, the portable computing device 100 may further include various components, such as a communication module, a GPS module, a speaker, or a microphone, etc., required for the functionality of the portable computing device 100 or the user's convenience.

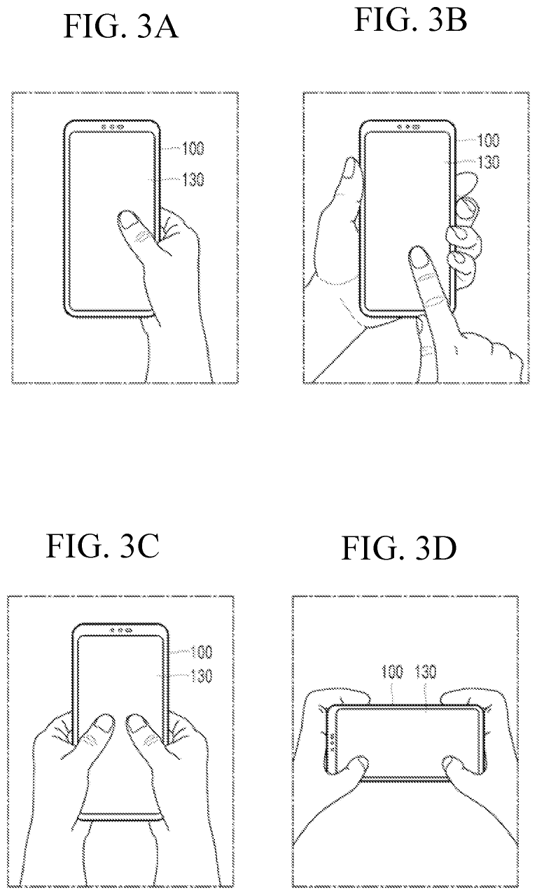

FIGS. 3A to 3D are diagrams showing various examples of a method for gripping the portable computing device by a user. In FIG. 3A, the user grips the portable computing device 100 in a vertical (portrait) orientation with a right hand and touches the touch screen 130 with a right hand thumb. In FIG. 3B, the user grips the portable computing device 100 with a left hand and touches the touch screen 130 with a right hand index finger. In FIG. 3C, the user grips the portable computing device 100 with both hands and touches the touch screen 130 with thumbs of both hands. In FIG. 3D, the user grips the portable computing device 100 with both hands, but grips in a horizontal (landscape) orientation. In addition to the examples of FIGS. 3A to 3D, there may be various methods for gripping the portable computing device. The user's preferred method for gripping the portable computing device may be various depending on the user. The user unconsciously grips and uses the portable computing device in his/her preferred method. The various methods for gripping the portable computing device may cause various touch data and motion data.

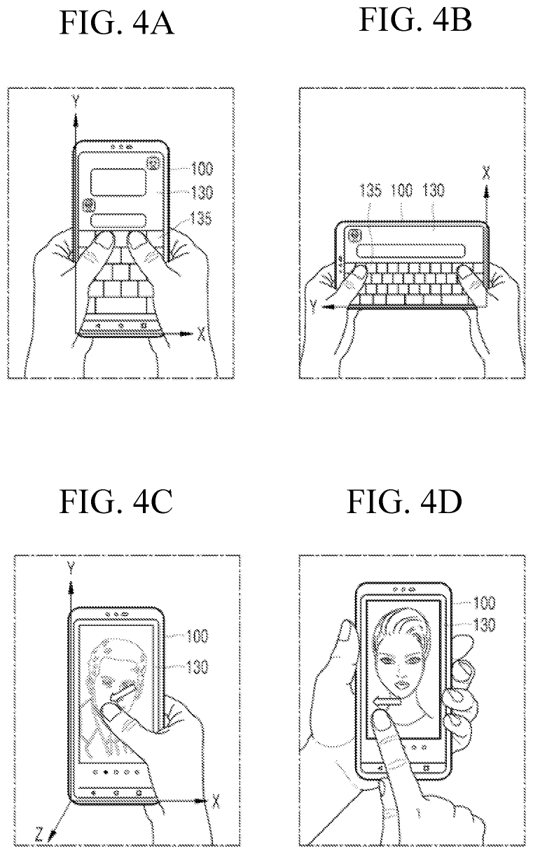

FIGS. 4A to 4D are diagrams showing the examples in which various gripping methods of the portable computing device cause various touch data depending on the executed application.

FIGS. 4A and 4B are diagrams showing the examples of inputting a text message into an instant messenger in a vertical (portrait) orientation and a horizontal (landscape) orientation, respectively. In an example of FIG. 4A, the user grips the portable computing device 100 in a vertical (portrait) orientation and touches the virtual keyboard 135 on the touch screen with the thumbs of both hands. In this example, the touch data biased toward the lower side in the y-direction of the touch screen 130 may be generated.

In an example of FIG. 4B, the user grips the portable computing device 100 in a horizontal (landscape) orientation and touches the virtual keyboard 135 on the touch screen 130 with the thumbs of both hands. In this example, the touch data biased toward the lower side in the x-direction of the touch screen 130 may be generated.

FIGS. 4C and 4D are diagrams showing the examples of a touch operation using a photo sharing social media service according to a one-handed gripping method and a two-handed gripping method.

In an example of FIG. 4C, the user places the y-directional bottom portion of the portable computing device 100 on a right hand pinky and the z-directional back surface of the portable computing device 100 on a right hand index finger, middle finger, and ring finger. The user drags the right hand thumb on the touch screen 130 in a manner that is rotated around the right lower end portion of the portable computing device 100 in order to scroll the image. In this example, touch data (drag data) corresponding to an arc having a center of curvature at the right lower end of the touch screen and having a relatively small radius of curvature may be generated.

In an example of FIG. 4D, the user grips the portable computing device 100 with all the fingers and palm of the left hand, and drags a right hand index finger in an almost straight line toward the right on the touch screen 130 in order to scroll the image. In this example, touch data (drag data) corresponding to an almost straight line having a considerably large radius of curvature may be generated.

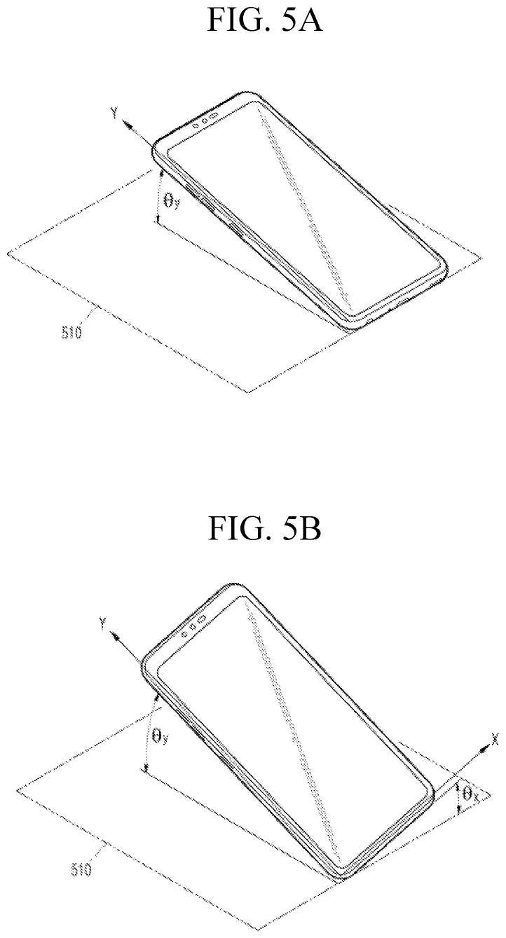

FIGS. 5A and 5B are diagrams showing the examples in which various gripping methods of the portable computing device cause various motion data.

FIG. 5A shows the orientation of the portable computing device 100 when the user has gripped the portable computing device 100, for example, by the method of FIG. 4C. In an example of FIG. 5A, the y-axis of the portable computing device is oriented to have a low elevation angle (θ_{y}) with respect to the horizontal plane.

FIG. 5B shows the orientation of the portable computing device 100 when the user has gripped the portable computing device 100, for example, by the method of FIG. 4D. In an example of FIG. 5B, the y-axis of the portable computing device 100 may be oriented to have a relatively high elevation angle (θ_{y}) with respect to the horizontal plane, and the x-axis of the portable computing device 100 may form an elevation angle (Ox) inclined with respect to the horizontal plane.

As shown in FIGS. 3A to 5B, there may be various methods for gripping the portable computing device depending on the user's preference, and various patterns of touch data and motion data depending on the method for gripping the portable computing device and the executed application may be generated. The user habitually grips the portable computing device in a specific method in a specific situation (e.g., depending on the application being executed). Accordingly, patterns of the touch data and/or the motion data when a specific application is executed may be utilized as authentication data to identify a user.

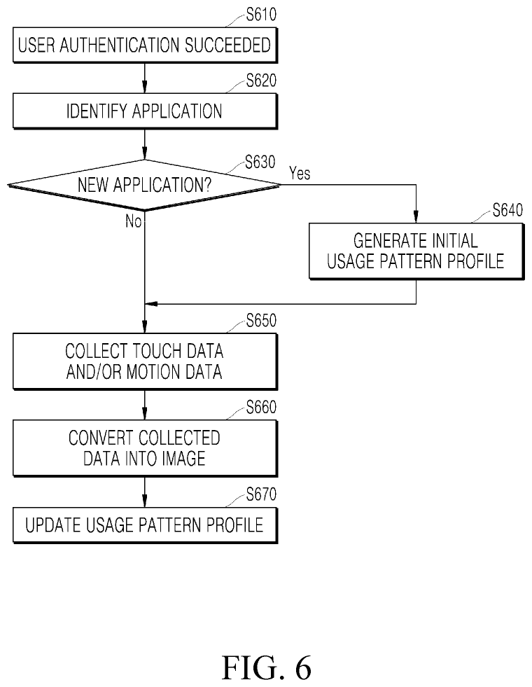

FIG. 6 is a flowchart showing a method for generating and learning a usage pattern profile in the portable computing device according to an embodiment of the present disclosure.

Referring to FIG. 6, in step S610, the portable computing device 100 authenticates a user, and unlocks the portable computing device 100 for use of the authenticated user. The user authentication may be performed by means of any authentication method known to those skilled in the art, such as the input of a PIN or a predetermined pattern on the touch screen 130 or biometric identification using the biometric sensor 150.

In step S620, the portable computing device 100 identifies the application 123 executed on the operating system 122 of the portable computing device 100. When a plurality of applications are simultaneously executed on the operating system 122, the portable computing device 100 may identify one application 123 executed in the foreground. That is, the portable computing device 100 may identify the application 123 associated with a user interface (UI) or user experience (UX) that appears on the touch screen 130 of the portable computing device 100.

In step S630, the portable computing device 100 determines whether the identified application 123 is a new application that has not been previously executed in the portable computing device 100. In an embodiment, the operating system 122 of the portable computing device 100 may manage execution counts for the respective applications 123. The portable computing device 100 may determine whether the identified application 123 is a new application by referring to the execution count for the identified application. In another embodiment, the portable computing device 100 may determine whether the identified application is a new application by searching the usage pattern profile 128 associated with the identified application 123 in the memory 120.

If the identified application is a new application, in step S640, the portable computing device generates an initial usage pattern profile for the identified application. The usage pattern profile stores parameters and weights that define the architecture of the artificial neural network (machine learning model). The initial usage pattern profile may be a nominal usage pattern profile in which parameters and weights have been set to predetermined (default) values.

In another embodiment, the portable computing device 100 may also generate the initial usage pattern profile when a new application is installed. In this case, the steps S630 and S640 may be omitted.

In step S650, the portable computing device 100 collects touch data and/or motion data during execution of the application 123. In an embodiment, the collected touch data and motion data may be raw data provided from the touch screen 130 and the three-dimensional motion sensor 140, respectively. In another embodiment, the collected touch data and motion data may be data preprocessed by the operating system 122 or by a separate application so as to be understandable by a programmer or an application on the operating system 122.

The preprocessed touch data may include, for example, touch coordinates, touch state (touch is made, touch is released, touch is moved (drag or swipe)), the number of multi-touches, drag distance, a touch time point (a time point when the touch is made, a time point when the touch is released), or a touch duration on the touch screen 130, but is not limited thereto.

The preprocessed motion data may include, for example, angles (elevation angles) of the x-axis, y-axis, and z-axis of the portable computing device with respect to the horizontal plane, and a moving distance, a moving speed, or acceleration of the portable computing device 100 in each of the x-direction, y-direction, and z-direction, but is not limited thereto.

The portable computing device 100 may collect touch data and/or motion data for a predetermined time. In an embodiment, the predetermined time may be determined depending on the characteristics of the executed application. For example, in the case of a game, since a relatively large amount of touch data and motion data are generated during a unit time, the portable computing device 100 may collect touch data and motion data for a relatively short time (e.g., 10 seconds). In the case of a web browser, since a relatively small amount of touch data and motion data is generated during a unit time, the portable computing device 100 may collect touch data and motion data for a relatively long time (e.g., 1 minute).

In step S660, the portable computing device 100 converts the collected touch data and/or motion data into image data. The image data may be in the form of an RGB image, for example, and may have a size (resolution) suitable for input to an input layer of a machine learning model. A method for converting touch data and motion data into image data will be described in detail below.

In step S670, the portable computing device 100 updates the usage pattern profile associated with the executed application using the touch data and/or the motion data. For example, the portable computing device 100 applies the data converted into the RGB image form as training data to the machine learning model of the artificial neural network. In an embodiment, the RGB image of the touch data and the RGB image of the motion data may be merged for each channel to generate one RGB image, and the merged RGB image may be input to the input layer of the machine learning model. The machine learning model updates the parameters and weights that define the architecture of the artificial neural network using the input data.

The machine learning model may include, for example, an Artificial Neural Network (ANN) using a deep learning technology, and may be implemented as a hardware module and/or a software module.

ANN is a data processing system modeled after the mechanism of biological neurons and interneuron connections, in which a number of neurons, referred to as nodes or processing elements, are interconnected in layers. ANNs are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections, and acquires problem-solving capability as the strengths of synaptic interconnections are adjusted throughout training. An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a previous layer.

An ANN may include a deep neural network (DNN). Specific examples of the DNN include a convolutional neural network (CNN), a recurrent neural network (RNN), a deep belief network (DBN), and the like, but are not limited thereto.

An ANN may be classified as a single-layer neural network or a multi-layer neural network, based on the number of layers therein. In general, a single-layer neural network may include an input layer and an output layer. In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron may be activated and output an output value obtained through an activation function.

A deep neural network with a plurality of hidden layers between the input layer and the output layer may be the most representative type of artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Accordingly, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

Further, the artificial neural network may be trained by adjusting weights of connections between nodes (if necessary, adjusting bias values as well) so as to produce a desired output from a given input. Also, the artificial neural network may continuously update the weight values through training. Furthermore, a method of back propagation or the like may be used in the learning of the artificial neural network.

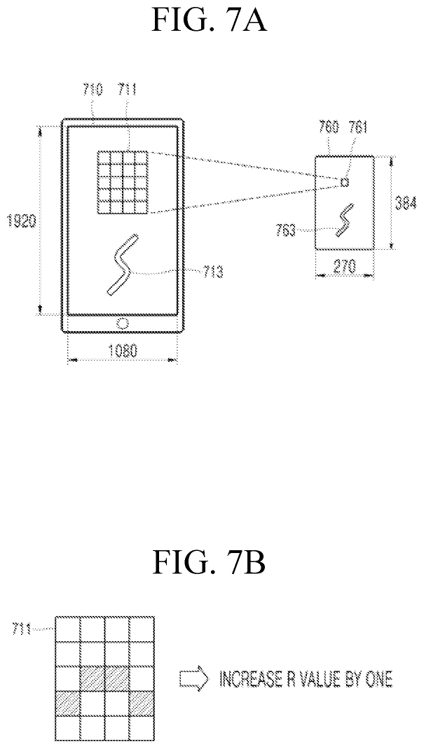

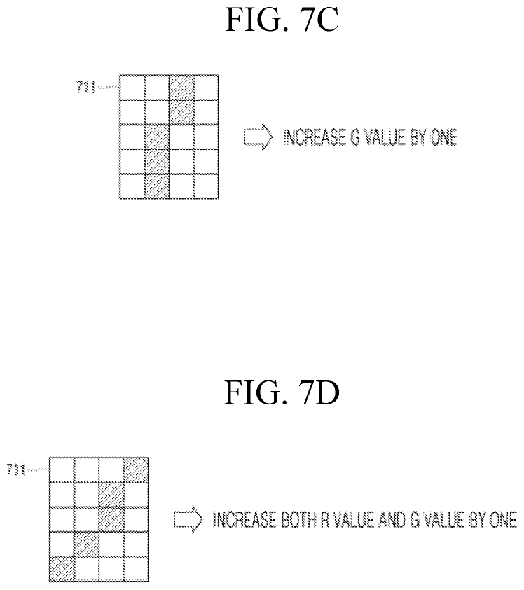

FIGS. 7A to 7D are diagrams showing a method for converting touch data into image data according to an embodiment of the present disclosure.

Referring to FIG. 7A, for example, pixels of a touch screen 710 having a resolution of 1080×1920 are converted into an RGB image 760 having a resolution of 270×384, for example. The size (resolution) of the RGB image 760 may be set to the size suitable for input to the input layer of the artificial neural network, and may have various sizes depending on performance of a processor performing the computation of the artificial neural network.

A 4×5 pixel block 711 of the touch screen 710 corresponds to one point 761 of the RGB image 760. A drag 713 in a curved shape on the touch screen 710 converts the RGB image 760 into a curved line 763 scaled with a factor of ¼ in the x-direction and a factor of ⅕ in the y-direction.

The red component (r value) of the point 761 in the RGB image 760 may be determined by the number of times at which the touch is dragged in the x-direction in the 4×5 pixel block 711 of the touch screen 710, and the green component (g value) of the point 761 in the RGB image 760 may be determined by the number of times at which the touch is dragged in the y-direction in the 4×5 pixel block 711 of the touch screen 710.

In an example of FIG. 7B, the drag traverses the pixel block 711 completely in the x-direction. Accordingly, the r value of the point 761 corresponding to the pixel block 711 increases by one. However, the drag does not traverse the pixel block 711 completely in the y-direction. Accordingly, the g value of the point 761 corresponding to the pixel block 711 does not increase.

In an example of FIG. 7C, the drag traverses the pixel block 711 completely in the y-direction. Accordingly, the g value of the point 761 corresponding to the pixel block 711 increases by one. However, the drag does not traverse the pixel block 711 completely in the x-direction. Accordingly, the r value of the point 761 in the RGB image corresponding to the pixel block 711 does not increase.

In an example of FIG. 7D, the drag traverses the pixel block 711 completely in the x-direction and in the y-direction. Accordingly, the r value and the g value of the point 761 corresponding to the pixel block 711 increase by one, respectively.

When the drag is repeated to the same pixel block 711, the r value and/or the g value of the point 761 corresponding to the pixel block 711 repeatedly increases.

The blue component (b value) of the point 761 in the RGB image 760 may be determined by the duration of the touch in the 4×5 pixel block 711 of the touch screen 710. For example, when a touch lasts for 0.1 second in the pixel block 711, the b value of the corresponding point 761 may increase by one. The b value may increase with the accumulation of the duration of the touch. For example, when a touch for 0.1 second, a touch for 1 second, and a touch for 0.5 second are made in the same pixel block 711, the b value of the corresponding point 761 may increase by (1+10+5=16).

The r, g, and b values of the points in the RGB image 760 may accumulate and increase for a predetermined time for generating touch data, and the accumulated r, g, and b values may be, for example, normalized to have values of 0 to 255. Accordingly, the touch data accumulated for the predetermined time can be converted into one RGB image 760.

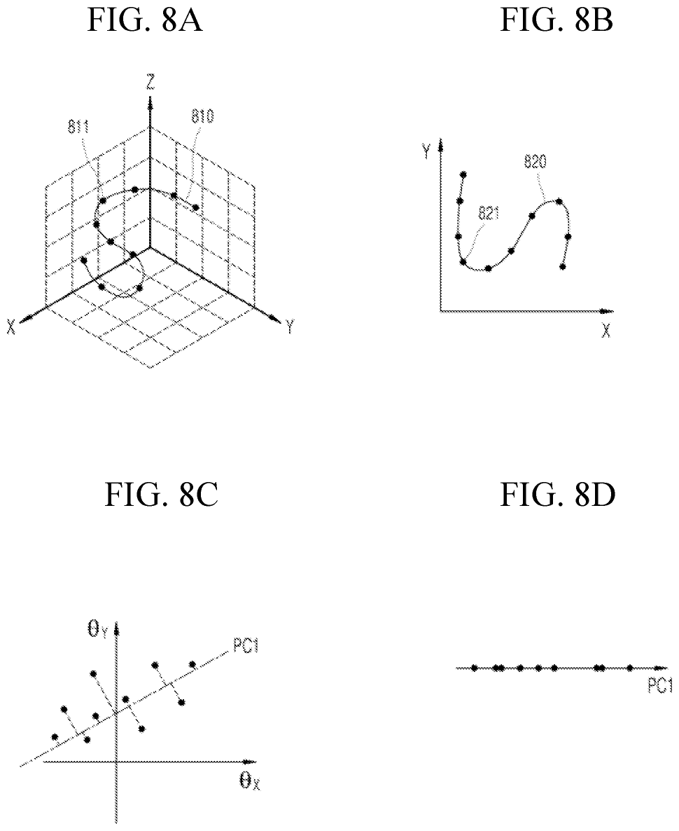

FIGS. 8A to 8D are diagrams showing a method for converting motion data into image data according to an embodiment of the present disclosure.

FIG. 8A shows an example of a moving trace 810 of the portable computing device 100 in three-dimensional space. The x, y, z coordinates of the portable computing device 100 in three-dimensional space may be obtained, for example, by double integrating the acceleration signals (AccX, AccY, AccZ) from the accelerometer sensor 143, respectively. The moving trace 810 of the portable computing device 100 in three-dimensional space is projected onto the x-y plane to generate a two-dimensional image 820 as shown in FIG. 8B. The x, y coordinates of each point 821 in the image 820 are normalized so that the generated image 820 has the size (e.g., a resolution of 270×384) suitable for input to the input layer of the artificial neural network. That is, the normalized x coordinate may have values of 0 to 269, and the normalized y coordinate may have values of 0 to 383.

The red component (r value) at each point 821 of the image 820 may be determined by the elevation angle (Ox) of the x-axis and the elevation angle (θ_{y}) of the y-axis of the portable computing device 100 at the time point corresponding to its point 821. For example, the elevation angle (Ox) of the x-axis and the elevation angle (00 of the y-axis of the portable computing device 100 at a plurality of time points may have a distribution as shown in FIG. 8C. The distribution data of the elevation angle (Ox) on the x-axis and the elevation angle (θ_{y}) on the y-axis are dimension-reduced by Principal Component Analysis (PCA) to generate one-dimensional data as shown in FIG. 8D. The one-dimensional data may be normalized to have values of 0 to 255, for example. Accordingly, the r value of each point 821 in the image 820 of FIG. 8B may be determined by the value of the corresponding point 841 in FIG. 8D.

The green component (g value) of each point 821 in the image 820 may be determined by the z-coordinate of the point 811 in three-dimensional space corresponding to its point. For example, the z-coordinate of a three-dimensional moving trajectory 810 in FIG. 8A may be normalized to have values of 0 to 255. The g value of each point 821 in the image 820 may have a normalized z-value of the corresponding point 811 on the three-dimensional moving trajectory 810.

The blue component (b value) of each point 821 in the image 820 may be determined by the occupancy time of the portable computing device in three-dimensional space corresponding to its point 821. The b value may accumulate and increase for a predetermined time for generating motion data, and the accumulated b value may be normalized to have values of 0 to 255, for example. As described above, the motion data accumulated for the predetermined time may be converted into one RGB image.

In an embodiment of FIGS. 7A to 8D, the touch data is converted into one RGB image, and the motion data is converted into the other RGB image. However, the touch data and the motion data may be converted together into one RGB image. Multiple data may be converted into data for generating a two-dimensional RGB image through calculations between each other and/or dimensional reduction algorithm (e.g., PCA). The above-described method for generating the RGB image is merely illustrative, and various methods may also be used depending on the number and forms of available data. Further, although the touch data and the motion data have been exemplified as being input to the artificial neural network in the form of the RGB image in the above-described embodiment, various types of data depending on the characteristics of the input layer of the artificial neural network may also be input to the artificial neural network.

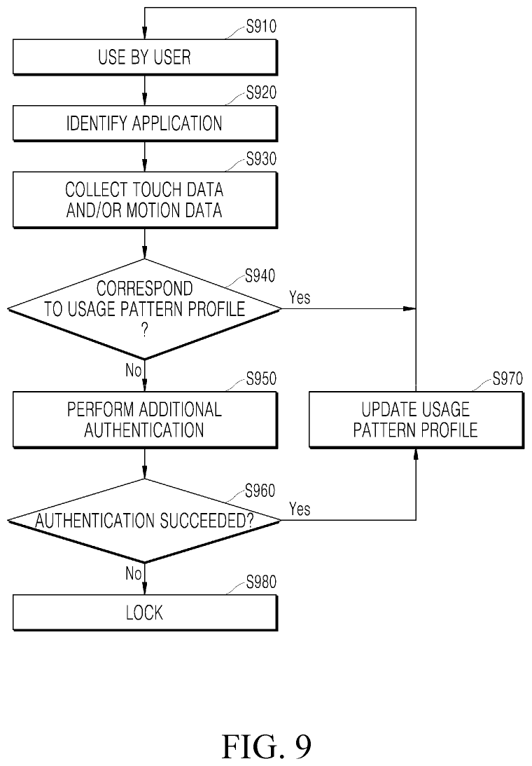

FIG. 9 is a flowchart showing a method for authenticating a user according to a usage pattern in the portable computing device according to an embodiment of the present disclosure.

Referring to FIG. 9, in step S910, the portable computing device 100 is being used by a user in an unlocked state. For example, the portable computing device 100 was unlocked by means of any authentication method, such as the input of a PIN or a predetermined pattern, or biometric identification, and is being used by the user.

In step S920, the portable computing device 100 identifies the application 123 executed on the operating system 122 of the portable computing device 100. When a plurality of applications are simultaneously executed on the operating system 122, the portable computing device 100 may identify one application 123 executed in the foreground. That is, the portable computing device 100 may identify the application 123 associated with the user interface (UI) or the user experience (UX) that appears on the touch screen 130 of the portable computing device 100.

In step S930, the portable computing device 100 collects touch data from the touch screen 130 of the portable computing device 100 and/or motion data from the three-dimensional motion sensor 140 of the portable computing device 100 during execution of the application 123. In an embodiment, the collected touch data and motion data may be raw data provided from the touch screen 130 and the three-dimensional motion sensor 140, respectively. In another embodiment, the collected touch data and motion data may be data preprocessed by the operating system 122 or by a separate application to be understandable by a programmer or an application on the operating system 122.

The preprocessed touch data may include, for example, touch coordinates, touch state (touch is made, touch is released, touch is moved (drag or swipe)), the number of multi-touches, drag distance, a touch time point (a time point when the touch is made, a time point when the touch is released), or a touch duration on the touch screen 130, but is not limited thereto.

The preprocessed motion data may include, for example, angles (elevation angles) of the x-axis, y-axis, and z-axis of the portable computing device with respect to the horizontal plane, and a moving distance, a moving speed, or acceleration of the portable computing device 100 in each of the x-direction, y-direction, and z-direction, but is not limited thereto.

The portable computing device 100 may collect touch data and/or motion data for a predetermined time. In an embodiment, the predetermined time may be determined as a function of the characteristics of the executed application. For example, in the case of a game, since a relatively large amount of touch data and motion data are generated during a unit time, the portable computing device 100 may collect touch data and motion data for a relatively short time (e.g., 10 seconds). In another embodiment, the predetermined time may be determined as a function of the number of times at which the usage pattern authentication has succeeded successively, and a description thereof will be made later.

In step S940, the portable computing device 100 performs usage pattern authentication using the collected touch data and/or motion data. Specifically, the portable computing device 100 determines whether the pattern of collected touch data and/or motion data corresponds to the usage pattern profile 128 associated with the identified application 123. In an embodiment, the portable computing device 100 may convert the collected touch data and motion data into an RGB image, in accordance with the method described with reference to FIGS. 7A to 8D. The portable computing device 100 inputs the converted RGB image into the artificial neural network trained with the usage pattern profile 128 associated with the identified application 123. The artificial neural network may output the degree (e.g., similarity) to which the input RGB image corresponds to the usage pattern profile 128 associated with the identified application 123.

If it is determined that the pattern of the collected touch data and motion data corresponds to the usage pattern profile 128 associated with the identified application 123 (i.e., the similarity output from the artificial neural network is above a reference value), then the portable computing device 100 is kept in a unlocked state to allow the use of the user (return to the step S910).

If it is determined that the pattern of the collected touch data and motion data does not correspond to the usage pattern profile 128 associated with the identified application 123 (i.e., the similarity output from the artificial neural network is smaller than the reference value), then the portable computing device 100 performs additional measures for authenticating the user in step S950.

In an embodiment, the portable computing device 100 may activate the camera 151 to recognize a face or an iris of the user. In this embodiment, the portable computing device 100 may perform the user authentication in a manner that does not disturb the user and is not recognized by the user.

In another embodiment, the portable computing device 100 may output a user interface for the user authentication on the touch screen 130. For example, the portable computing device 100 may output an interface for inputting a PIN or an unlock pattern, and may request the user's input. The portable computing device 100 may authenticate the user by comparing the input from the user with the PIN information 125 or the unlock pattern information 126 stored in the memory 120.

In still another embodiment, the portable computing device 100 may output a user experience (UX) screen of the application frequently used by a user, which is different from the executed application, and request the user to perform the touch input as usual. The portable computing device 100 may collect touch data and/or motion data for the predetermined time, and compare the pattern of the collected touch data and/or motion data with the usage pattern profile for the application frequently used by the user to authenticate the user.

If the user authentication succeeds by additional measures, the touch data and/or the motion data that have been collected in the step S930 should be evaluated as being generated by the use of the legitimate user. In step S970, the portable computing device 100 inputs the collected motion data and/or touch data as training data into the artificial neural network, and updates the usage pattern profile 128 associated with the identified application 123 so as to reflect the pattern of the collected touch data and/or motion data.

If the user authentication fails even by additional measures, in step S980, the portable computing device 100 enters the locked state so as to block the user access. Accordingly, it is possible to effectively block the use of the portable computing device 100 by someone else.

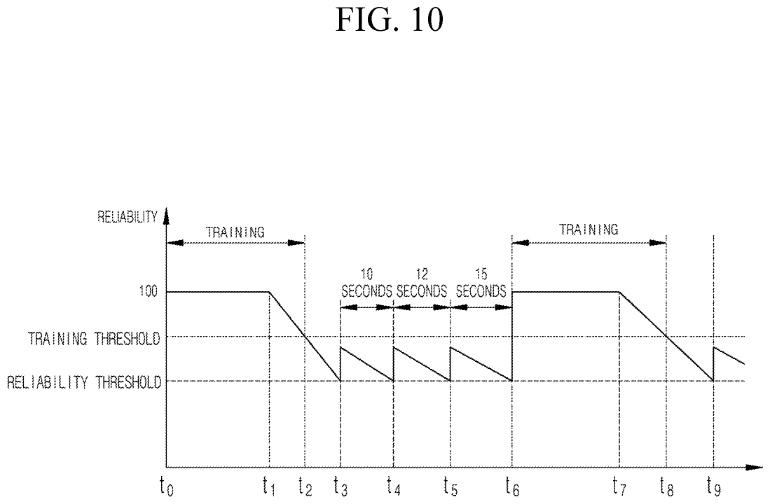

FIG. 10 is a graph showing the time points when data training and usage pattern authentication are performed according to an embodiment of the present disclosure.

Referring to FIG. 10, the user authentication through biometric authentication succeeds at a time point t0. Since the biometric authentication is regarded as the most reliable authentication method, the reliability reaches 100% at the time point t0. Further, since it is likely to be used by a legitimate user for a predetermined time (e.g., 1 minute) after the biometric authentication, the reliability is kept at 100% until a time point t1.

The reliability reduces as time passes from the time point t1. At a time point t2, the reliability goes below a training threshold. Since the touch data and/or motion data when the reliability is above the training threshold is regarded as being generated by the use of the legitimate user, the touch data and motion data from the time point t0 to the time point t2 are used as the training data for the artificial neural network. That is, the method according to an embodiment of FIG. 6 may be performed from the time point t0 to the time point t2.

From the time point t2, the method according to an embodiment of FIG. 9 may be performed. At a time point t3, the reliability reduces to a reliability threshold and first usage pattern authentication is performed. If the usage pattern authentication succeeds, the reliability increases to some extent, and then the reliability reduces again as time passes.

At a time point t4, the reliability again reduces to the reliability threshold and second usage pattern authentication is performed. If the usage pattern authentication succeeds, the reliability increases to some extent, and then the reliability reduces again as time passes. At a time point t5, the reliability reaches the reliability threshold and third usage pattern authentication is performed. Similarly, fourth usage pattern authentication is performed at a time point t6.

At this time, the time length (t5−t4) between the second usage pattern authentication (t4) and the third usage pattern authentication (t5) may be longer than the time length (t4−t3) between the first usage pattern authentication (t3) and the second usage pattern authentication (t4). Further, the time length (t6−t5) between the third usage pattern authentication (t5) and the fourth usage pattern authentication (t6) may be longer than the time length (t5−t4) between the second usage pattern authentication (t4) and the third usage pattern authentication (t5). For example, t4−t3 may be 10 seconds, t5−t4 may be 12 seconds, and t6−t5 may be 15 seconds. That is, as the success of the usage pattern authentication is repeated, the reliability at the time of success of the usage pattern authentication may be greatly increased, or the reliability may be reduced more slowly as time passes.

In an example of FIG. 10, the fourth usage pattern authentication fails at the time point t6, and the biometric authentication which is performed as the additional measures succeeds. As a result of the success of biometric authentication, the touch data and/or motion data from the time point t5 to the time point t6, which have been used for the fourth usage pattern authentication, are input to the artificial neural network as training data to update the usage pattern profile associated with the application in use.

Meanwhile, as a result of the success of biometric authentication at the time point t6, the reliability reaches 100% at the time point t6 and is kept at 100% for the predetermined time (until a time point t7). Again, the reliability begins to reduce from a time point t8, and then operations are performed similarly after the time point t2.

If the success of the usage pattern authentication is repeated, the time length between the n^{th} usage pattern authentication and the (n+1)^{th} usage pattern authentication may become longer gradually. However, the time length between the n^{th} usage pattern authentication and the (n+1)^{th} usage pattern authentication may be limited so as not to be longer than a maximum of 1 minute, for example. The time length between the usage pattern authentications described above is merely illustrative, and may be set variously depending on the characteristics of the executed application.

According to the above-described embodiments of the present disclosure, it is possible to authenticate in real time whether the legitimate user is using the portable computing device 100. Further, it is possible to authenticate the user only with the usage pattern using the application without requiring a specific response or operation from the user. Accordingly, it is possible to authenticate the user using the portable computing device in real time without disturbing the user.

The above-described methods according to the embodiments of the present disclosure may be performed by the processing unit 110 according to the program codes or instructions of the usage pattern authentication agent integrated as part of the operating system 122 of the portable computing device 100. The usage pattern authentication agent may also be implemented by a separate program executed in the background of the operating system 122.

The computer programs may be those specially designed and constructed for the purposes of the present disclosure or they may be of the kind well known and available to those skilled in the computer software arts. Examples of program code include both machine code, such as produced by a compiler, and higher level code that may be executed by the computer using an interpreter.

As used in the present application (especially in the appended claims), the terms ‘a/an’ and ‘the’ include both singular and plural references, unless the context clearly states otherwise. Also, it should be understood that any numerical range recited herein is intended to include all sub-ranges subsumed therein (unless expressly indicated otherwise) and Accordingly, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example”, etc.) used herein are merely to describe the present disclosure in greater detail. Accordingly, it should be understood that the scope of the present disclosure is not limited to the example embodiments described above or by the use of such terms unless limited by the appended claims. Also, it should be apparent to those skilled in the art that various alterations, permutations, and modifications may be made within the scope of the appended claims or equivalents thereof.

The present disclosure is not limited to the example embodiments described above, and rather intended to include the following appended claims, and all modifications, equivalents, and alternatives falling within the spirit and scope of the following claims.

What is claimed is:

1. A method for authenticating a user of a portable computing device, comprising:
identifying an application executed on the portable computing device;
collecting touch data on the portable computing device and/or motion data of the portable computing device during execution of the application; and
determining whether a pattern of the collected touch data and/or motion data corresponds to a usage pattern profile associated with the identified application.

2. The method of claim 1,
wherein collecting the touch data and/or the motion data comprises collecting the touch data and/or the motion data for a predetermined time depending on the identified application.

3. The method of claim 1,
wherein the touch data comprises at least one of a touch coordinate, a number of multi-touches, a number of touch times, or a touch duration on a touch screen.

4. The method of claim 1,
wherein the motion data comprises at least one of acceleration data or rotation data of the portable computing device in three-dimensional space.

5. The method of claim 1,
wherein determining comprises inputting the collected touch data and/or motion data to an artificial neural network trained to output a corresponding degree between a usage pattern profile associated with the artificial neural network and input data.

6. The method of claim 5, further comprising converting the collected touch data and/or motion data into image data,
wherein inputting the touch data and/or the motion data comprises inputting the converted image data.

7. The method of claim 1, further comprising performing additional measures for authenticating the user of the portable computing device in response to a determination that the pattern of the collected touch data and/or motion data does not correspond to the usage pattern profile associated with the application.

8. The method of claim 1, further comprising:
generating a usage pattern profile associated with a new application in response to an installation or first execution of the new application on the portable computing device;
collecting the touch data on the portable computing device and/or the motion data of the portable computing device during execution of the new application; and
updating the usage pattern profile associated with the new application using the collected touch data and/or motion data.

9. A computer readable storage medium storing one or more programs,
wherein the one or more programs comprise computer program instructions configured to perform, when executed by a processor of a portable computing device, the method of claim 1.

10. A portable computing device, comprising:
a touch screen configured to sense touch on a touch screen to generate touch data;
a three-dimensional motion sensor configured to sense a motion in three-dimensional space of the portable computing device to generate motion data;
one or more processors configured to execute one or more applications; and
a memory configured to store one or more usage pattern profiles wherein the one or more usage pattern profiles are associated with the one or more applications, respectively,
wherein the one or more processors are operable to
identify an application being executed,
collect the touch data and/or the motion data from the touch screen and/or the three-dimensional motion sensor during execution of the application, and
determine whether a pattern of the collected touch data and/or motion data corresponds to the usage pattern profile associated with the identified application.

11. The portable computing device of claim 10,
wherein the one or more processors are operable to collect the touch data and/or the motion data for a predetermined time depending on the identified application.

12. The portable computing device of claim 10,
wherein the touch data comprises at least one of a touch coordinate, a number of multi-touches, a number of touch times, or a touch duration on the touch screen.

13. The portable computing device of claim 10,
wherein the three-dimensional motion sensor comprises at least one of an accelerometer sensor or a gyroscope sensor.

14. The portable computing device of claim 10,
wherein the one or more processors are operable to determine whether the pattern of the touch data and/or the motion data corresponds to the usage pattern profile associated with the identified application using an artificial neural network trained to output a corresponding degree between a usage pattern profile associated with the artificial neural network and input data.

15. The portable computing device of claim 14,
wherein the one or more processors are operable to convert the collected touch data and/or motion data into image data, and to input the converted image data to the artificial neural network.

16. The portable computing device of claim 10,
wherein the one or more processors are operable to perform measures for authenticating the user of the portable computing device in response to a determination that the pattern of the collected touch data and/or motion data does not correspond to the usage pattern profile associated with the identified application.

17. The portable computing device of claim 10,
wherein the one or more processors are operable to
generate a usage pattern profile associated with a new application in response to an installation or first execution of the new application on the portable computing device,
collect the touch data and/or the motion data from the touch screen and the three-dimensional motion sensor during execution of the new application, and
update the usage pattern profile associated with the new application using the touch data and/or the motion data.
